(19) United States
(12) Patent Application Publication
(10) Pub. No.: US 2007/0242578 A1
(43) Pub. Date: Oct. 18, 2007

(54) Information recording medium in which pre-pit is formed and recording/reproducing apparatus and method

(75) Inventors: Shuichi Tasaka, Suwon-si (KR); Kyung-geun Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronic Co., Ltd., Suwon-si (KR)

(21) Appl. No.: 11/698,829

(22) Filed: Jan. 29, 2007

(30) Foreign Application Priority Data
Apr. 13, 2006 (KR) 2006-33744

(51) Int. Cl. G11B 7/12

(52) U.S. Cl. 369/47.49; 369/275.3; 369/59.25

(57) ABSTRACT

An information recording medium for enabling quick finalization and efficient data recording/reproducing, and a recording/reproducing apparatus and method are provided. The information storage medium includes a finalization area of which both of an in-groove pre-pit and a land pre-pit are formed in at least a part, while the information storage medium is manufactured.

### CROSS-REFERENCE TO RELATED APPLICATIONS

This application claims all benefits accruing under 35 U.S.C. §119 from Korean Patent Application No. 2006-33744, filed on Apr. 13, 2006, in the Korean Intellectual Property Office, the disclosure of which is incorporated herein by reference.

### BACKGROUND OF THE INVENTION

1. Field of the Invention

The present invention relates to an information recording medium, and more particularly, to an information recording medium having a structure enabling quick finalization and a recording/reproducing apparatus and method.

2. Related Art

Optical recording media, for example, optical discs, are widely used in an optical pickup apparatus that records/reproduces information using a non-contact method, and are divided into compact discs (CDs) and digital versatile discs (DVDs) according to a recording capacity. Optical discs which information can be recorded on, erased from, and reproduced from include a 650 MB CD-Recordable (R), a CD-Rewritable (RW), a 4.7 GB DVD+R/RW, a DVD-Random Access Memory (RAM), and a DVD-R/RW. A 650 MB CD and a 4.7 GB DVD-Read Only Memory (ROM) are examples of a read-only optical disc. In addition, there are high density (HD) DVDs and Blu-ray discs (BDs) that have a capacity of at least 15 GB. Moreover, an optical disc having a higher capacity, for example, a super Resolution Near field Structure (RENS) using super-resolution technology, have been developed to record data at higher densities and faster speeds.

Currently, DVD-RAM and DVD-RW generally have a recording data capacity of 4.7 GB in which information can be recorded on, erased and reproduced from. Specifically, each optical disc has grooves to guide an optical pick-up along certain tracks in a circumferential direction during a data recording operation. The grooves are formed during mastering of the optical disc, that is, when a stamper for a substrate is manufactured.

However, the greatest difference between a DVD-RAM and a DVD-RW is a recording area. In the DVD-RAM, data is recorded in both a groove area and a land area disposed between two adjacent grooves. In addition, a physical identifier (ID) region, which includes an address of a unit to allow a predetermined physical unit access, is formed in a form of a pit. In contrast, in the DVD-RW, data is recorded only in a groove area and no pits are formed. Instead, block addresses are formed in a land region as land pre-pits.

In addition, the DVD-RW has good recording/reproducing characteristics, such as a superior jitter characteristic due to the depth and width of the groove. Advantageous jitter characteristics provide better jitter margins to allow superior flexibility with optical read/write devices that may produce a transport spin speed too high or too low for the media. The width and depth of the grooves in a DVD-RW are determined for excellent jitter characteristics without pits. An appropriate depth of the DVD-RW grooves is about 20-40 mm, which can be expressed as λ/12 n, using the wavelength (λ) of a laser beam and the refractive index (n) of the disc. This groove depth of the DVD-RW is smaller than that of a DVD-RAM, which is expressed as λ/6 n.

FIGS. 1A through 1D are graphs illustrating a reproduction signal measured at different pit depths under the conditions that a wavelength is 650 nm, a numerical aperture is 0.60, and a minimum mark length is 0.42 μm. In FIGS. 1A through 1D, a horizontal axis represents time in terms of “ns”, and a vertical axis represents normalized values of the reproduction signal since the vertical axis is normalized. FIG. 1A illustrates a reproduction signal obtained when the depth of the pit is λ/3; FIG. 1B illustrates a reproduction signal obtained when the depth of the pit is λ/4; FIG. 1C illustrates a reproduction signal obtained when the depth of the pit is λ/6; and FIG. 1D illustrates a reproduction signal obtained when the depth of the pit is λ/12.

When the graph illustrated in FIG. 1A to 1B is normalized with a maximum value, that is, a signal produced from a pit having a depth usually used in a DVD-RAM, a graph illustrated in FIG. 2 is obtained. Referring to FIG. 2, when a pit has a depth of λ/12 (i.e., 0.08λ) or less, a reproduction signal obtained at a 3T or 14T mark has a level of about at most 30% of a level obtained when a pit has a depth of λ/4 (i.e., 0.25λ). With this low level, a reliable signal cannot be obtained. As a result, it is necessary to adjust the depth of the pit.

Since the pit and the groove in the DVD-RAM are formed in a depth of about λ/6, a push-pull signal from the groove and a reproduction signal from a pit can be obtained without a big problem. However, because the groove depth of a DVD-RW is much shallower and the pit has the same depth as the groove, a push-pull signal from the pit is difficult to obtain so as to normally record/reproduce a mark. As a result, the depth of the groove cannot be freely adjusted.

To address this problem, U.S. Pat. No. 5,501,926 provides a technique of manufacturing two types of pits or grooves having different depths using a special photoresist reacting on an optical disc and an etching process. However, drawbacks to this method may include complex manufacturing processes and high manufacturing costs.

U.S. Pat. No. 5,500,850 also discloses a process of manufacturing grooves with different depths. However, a problem arises in that the paths of two laser beams must be aligned very precisely in order to form grooves having different depths.

Likewise, an etching process can be utilized several times to define pits and grooves with different depths. In other words, a dual-depth disc can be manufactured using a plurality of etching processes. However, the manufacturing processes are very complicated and a production yield is not good. As a result, the production cost of such an optical disc can be very high.

To overcome these drawbacks, a method of forming grooves and pits with different depths has been proposed by controlling a power of a laser beam, as disclosed in Korean Patent Application No. 2000-0030034.

Nevertheless, there is still a need for a method of quickly finalizing an optical disc using these grooves and pits with different depths.

### SUMMARY OF THE INVENTION

Several aspects and example embodiments of the present invention provide a new technique to rapidly finalize an information recording medium during manufacture for efficient data recording/reproducing, and a recording/reproducing apparatus and method.

Additional aspects and/or advantages of the invention will be set forth in part in the description which follows and, in part, will be obvious from the description, or may be learned by practice of the invention.

In accordance with an example embodiment of the present invention, there is provided an information storage medium including a user data area to store user area; and a finalization area of which both of an in-groove pre-pit and a land pre-pit are formed in at least a part, while the information storage medium is manufactured.

According to an aspect of the present invention, an embossed pre-pit may be formed in at least a part of the finalization area of the information recording medium. The finalization area may include a middle area disposed between the user data area and one of a lead-in area and a lead-out area. The in-groove pre-pit and the land pre-pit may be formed adjacent to an area in which data recording or reproducing starts. Information indicating whether a pre-pit has been formed in the finalization area may be recorded in a predetermined area of the information storage medium. The predetermined area may include a lead-in area in the information storage medium or a control data area included in the lead-in area.

In accordance with another example embodiment of the present invention, there is provided a recording/reproducing apparatus for recording data on or reproducing data from an information storage medium. The recording/reproducing apparatus includes a write/read unit arrange to record data on or read data from the information storage medium comprising a finalization area of which both of an in-groove pre-pit and a land pre-pit are formed in at least a part, while the information storage medium is manufactured; and a control unit arranged to read information indicating that a pre-pit has been formed in the finalization area from a predetermined area in the information storage medium and control a data recording operation based on the information.

In accordance with still another example embodiment of the present invention, there is provided a recording/reproducing apparatus for recording data on or reproducing data from an information storage medium. The recording/reproducing apparatus includes a write/read unit arranged to record data on or read data from the information storage medium comprising a finalization area of which both of an in-groove pre-pit and a land pre-pit are formed in at least a part while the information storage medium is manufactured; and a control unit arranged to control the write/read unit to record data on or reproduce data from a data area adjacent to the finalization area referring to address information of a portion of the finalization area in which the in-groove pre-pit and the land pre-pit are formed.

In accordance with yet another example embodiment of the present invention, there is provided a method of recording data in or reproducing data from an information storage medium. The method includes reading information indicating that a pre-pit has been formed in a finalization area from a predetermined area in the information storage medium of which both of an in-groove pre-pit and a land pre-pit are formed in at least a part of the finalization area, while the information storage medium is manufactured; and controlling a data recording operation based on the information.

In accordance with a further embodiment of the present invention, there is provided a method of recording data in or reproducing data from an information storage medium. The method includes recording data in a data area adjacent to a finalization area in the information storage medium, or reproducing data from the data area adjacent to a finalization area in the information storage medium referring to address information of a portion of the finalization area of which both of an in-groove pre-pit and a land pre-pit are formed therein, while the information storage medium is manufactured.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1A through 1D illustrate the characteristics of reproduction signals obtained at different pit depths under the conditions that a wavelength is 650 nm, a numerical aperture is 0.60, and a minimum mark length is 0.42 μm;

FIG. 2 is a graph showing the result of normalizing the graph illustrated in FIG. 1A through 1D;

FIG. 3 is a schematic view of an information recording medium in which an area for finalization is formed in a form of a pre-pit according to an example embodiment of the present invention;

FIG. 4 is a perspective view of the layout of the information recording medium shown in FIG. 3 as a dual-layer disc, according to an example embodiment of the present invention;

FIG. 5 is a perspective view of the physical form of an area for finalization in the information recording medium shown in FIG. 3, according to an example embodiment of the present invention;

FIG. 6 is a perspective view of the physical form of an area for finalization in the information recording medium shown in FIG. 3, according to another example embodiment of the present invention;

FIG. 7 is a cross-section view of a border region shown in FIG. 5 or FIG. 6, according to an example embodiment of the present invention;

FIG. 8 is a view of an area in which information indicating that a pre-pit has been formed in an area for finalization of a medium is recorded, according to an example embodiment of the present invention;

FIG. 9 illustrates physical format information recorded in a control data area shown in

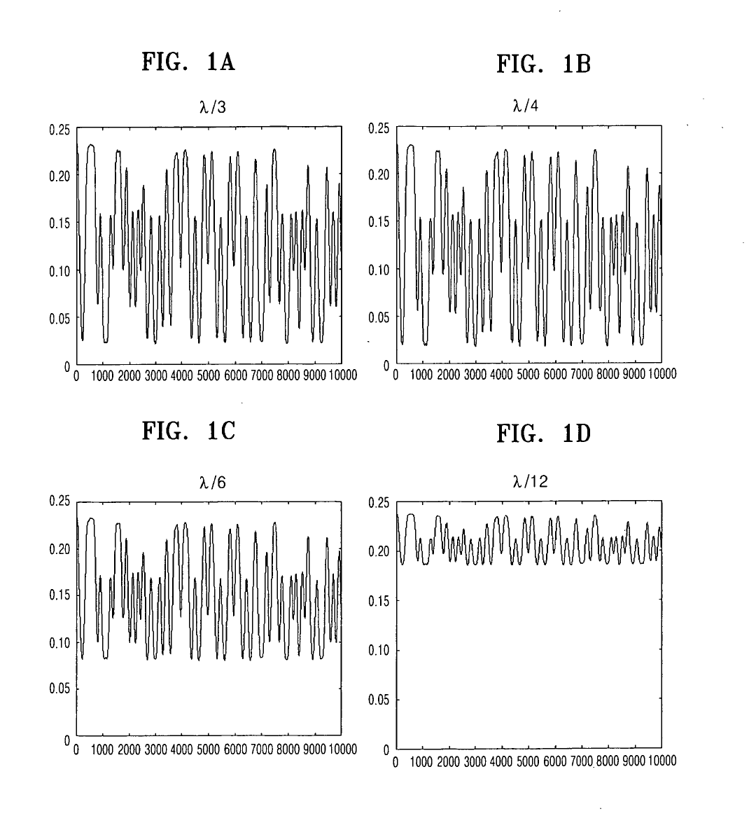

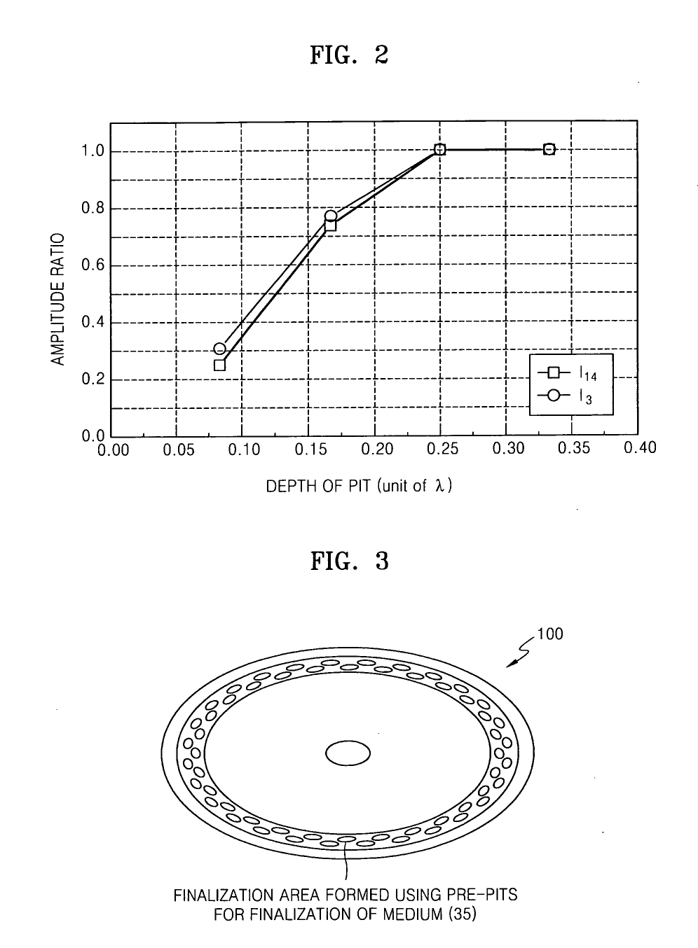

FIG. 8, according to an example embodiment of the present invention;

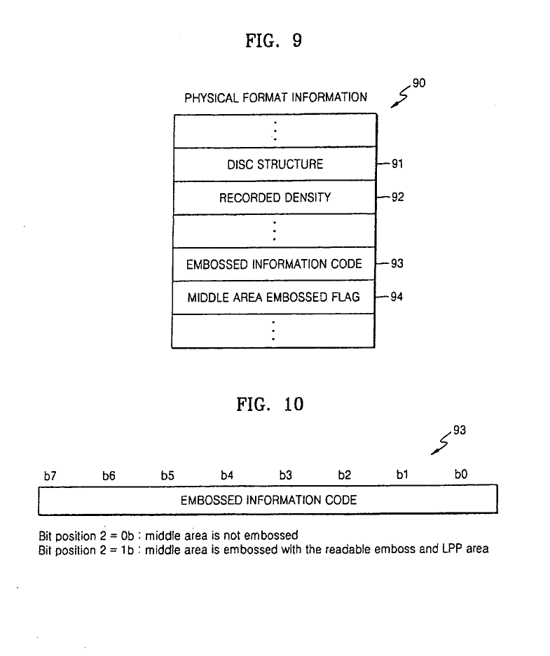

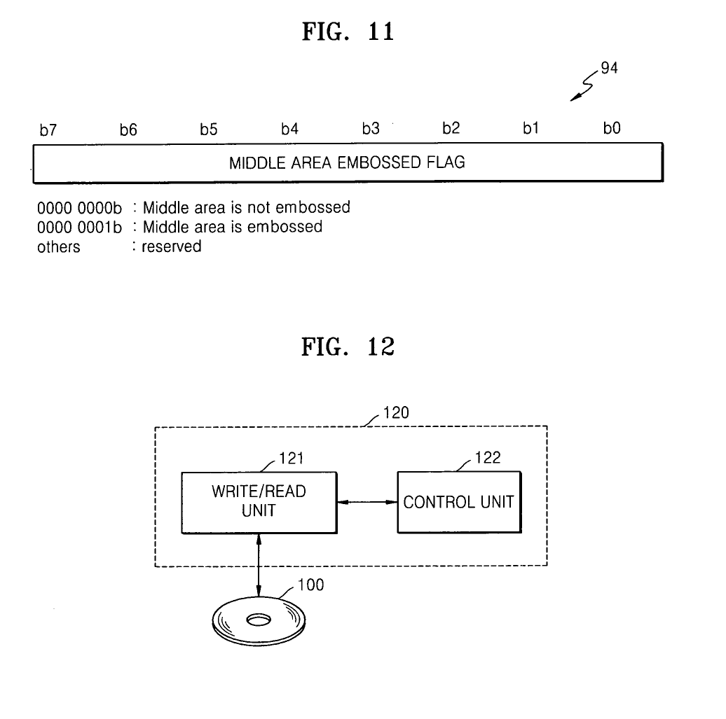

FIG. 10 illustrates an embossed information code shown in FIG. 9, according to an example embodiment of the present invention;

FIG. 11 illustrates a middle area embossed flag shown in FIG. 9, according to an example embodiment of the present invention; and

FIG. 12 is a schematic block diagram of a recording/reproducing apparatus for reading and using information indicating that a pre-pit is formed in an area for finalization of an information recording medium according to an example embodiment of the present invention.

### DETAILED DESCRIPTION OF THE EXAMPLE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 3 is a schematic view of an information recording medium 100 in which an area for finalization is formed in a form of a pre-pit according to an example embodiment of the present invention. Referring to FIG. 3, an area for finalization of the information recording medium 100 is formed using pre-pits in the information recording medium 100. Hereinafter, the area for the finalization is referred to as a finalization area 35.

Finalization of an information recording medium refers to a process performed to allow the use of the information recording medium only for data reproduction, while limiting further attempts by a user to record further data on the information recording medium. The finalization process of an information recording medium includes recording information indicating that the information recording medium is finalized in a particular area of the information recording medium and filling a predetermined area of the information recording medium with predetermined data. Conventionally, since the predetermined data is recorded in the particular area through a recording procedure, the finalization needs a large amount of time. However, in an embodiment of the present invention, the particular area designated for the finalization is formed by forming pre-pits in advance during the manufacturing of an information recording medium. As a result, time needed to fill the predetermined data in the particular area is reduced during the finalization of the information recording medium. Accordingly, the present invention enables an information recording medium to be finalized quickly. In particular, the reduction of finalization time makes a great effect for multi-layer information recording media where data can be recorded on one or more recording layers.

The particular area for the finalization of an information recording medium that should be filled with data for finalization may be different according to the specification or standards of an information recording medium. For example, the particular area designated for the finalization may include a middle area of an information recording medium, or may be a portion of a lead-in or lead-out area of the information recording medium or may be other areas of the information recording medium.

Meanwhile, when only pre-pits are formed in the finalization area 35, as shown in FIG. 3, problems may occur during recording. In particular, in order to start recording at a start point in a grooved area after information is read from pre-pits in the finalization area 35, it is necessary to precisely read a land pre-pit (LPP) signal, that is, an address signal of a groove. Here, the “grooved area” is a data recordable area including lands and grooves and may be a user data area or a test area. However, since only pre-pits having address information that can be referred to for data reproducing are formed in the finalization area 35 without an LPP, it may happen that a recording start point is displaced in the border of the finalization area 35 bordering the grooved area. When data is recorded in the border with the displacement of the recording start point, an error rate may be increased and the likelihood that block noise occurs on a screen with respect to the border while a title is reproduced is increased.

In contrary, when only LPPs are formed in the border of the finalization area 35, such as in the grooved area, since pre-pit data does not exist, the border is not read during reproducing, and therefore, block noise may be increased. In particular, when a pre-pit does not exist in such a border in a multi-layered optical disc, it is necessary to perform track jump on the border. As a result, design becomes complicated and an access time is increased.

To overcome these problems, in an embodiment of the present invention, a region providing the characteristics of both of an LPP signal and a pre-pit signal is formed in the finalization area 35 bordering the grooved area. Hereinafter, the region providing the characteristics of both of an LPP signal and a pre-pit signal is referred to as a “border region”. As described above, according to an example embodiment of the present invention, pre-pits are formed in advance in an area for finalization of a medium, thereby reducing a finalization time and the border region providing the characteristics of both of an LPP signal and a pre-pit signal is formed in the area for finalization, which borders a data recordable area, thereby allowing data to be efficiently recorded in/reproduced from the data recordable area.

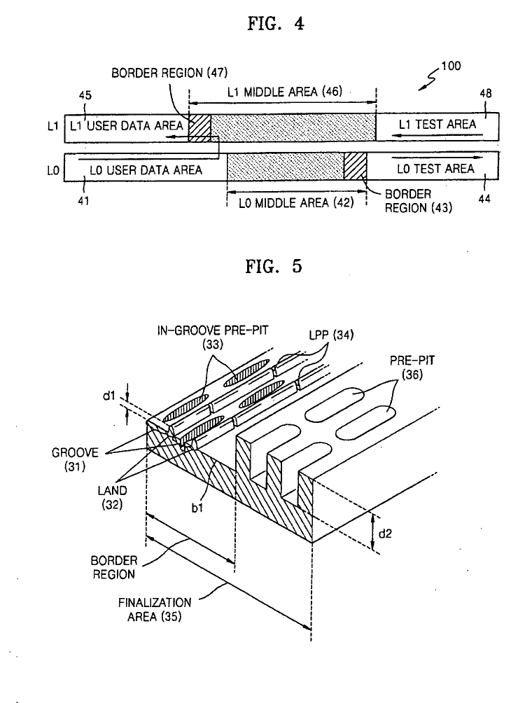

FIG. 4 illustrates an example layout of the information recording medium 100 shown in FIG. 3 as a dual-layered optical disc, according to an embodiment of the present invention. Referring to FIG. 4, the finalization area 35 includes an L0 middle area 42 and an L1 middle area 46. A middle area is provided for shift between layers in a multi-layered optical disc.

The information recording medium 100 has a dual-layer structure including a layer #0 (L0) and a layer #1 (L1). The layer #0 (L0) includes an L0 user data area 41, an L0 middle area 42, and an L0 test area 44. Similarly, the layer #1 (L1) includes an L1 user data area 45, an L1 middle area 46, and an L1 test area 48.

The L0 user data area 41 and the L1 user data area 45 are areas in which user data is recorded. The L0 middle area 42 and the L1 middle area 46 are areas for finalization of the information recording medium 100. The L0 test area 44 and the L1 test area 48 are areas in which data is recorded and reproduced to test recording conditions in order to achieve optimal power control.

According to the current embodiment, pre-pits are formed in the L0 middle area 42 and the L1 middle area 46 during manufacturing of the information recording medium 100 in order to quickly finalize the information recording medium 100. In addition, a border region providing the characteristics of both of an LPP signal and in-groove pre-pit signal is formed in a portion of a middle area adjacent to a data recordable area. In other words, a border region 43 is formed in a portion of the L0 middle area 42 close to the L0 test area 44, and a border region 47 is formed in a portion of the L1 middle area 46 close to the L1 user data area 45.

User data is recorded in a direction expressed by an arrow headed line shown in FIG. 4. User data is recorded starting from the left side of the L0 user data area 41. After the L0 user data area 41 is filled with user data, an optical pickup shifts to the layer L1. Then, the optical pickup is positioned at the L1 middle area 46 and moves to the left from that position to find a recording start point in the L1 user data area 45. At this time, the recording start point in the L1 user data area 45 can be easily found using an LPP signal of the border region 47 in front of the L1 user data area 45. In addition, when the user data is reproduced, a reproducing start point in the L1 user data area 45 can be easily found using an in-groove pre-pit signal of the border region 47.

Test data is recorded in directions expressed by arrow-headed lines in the L0 test area 44 and the L1 test area 48. Test data is recorded from the left to the right of the L0 test area 44 is recorded from the right to the left of the L1 test area 48. In order to find an exact recording start point in the L0 test area 44 when test data is initially recorded in the L0 test area 44, an LPP signal of the border region 43 in the L0 middle area 42 close to the L0 test area 44 is used. In addition, when the test data is reproduced, a reproducing start point can be easily found using an in-groove pre-pit signal of the border region 43 in the L0 middle area 42 close to the L0 test area 44.

In the current embodiment shown in FIG. 4, the border regions 43 and 47 are partially formed in the L0 middle area 42 and the L1 middle area 46, respectively. For example, each of the border regions 43 and 47 may be 16 ECC blocks and 1050 ECC blocks occupies the remaining region other than the border region in each of the middle areas 42 and 46. However, the present invention is not limited to the current embodiment. For example, a border region including both of an LPP and a groove pre-pit may be extended to an entire middle area. In other words, LPPs and groove pre-pits may be formed throughout a middle area.

FIG. 5 illustrates an example physical form of the finalization area 35 in the information recording medium 100 shown in FIG. 3, according to an embodiment of the present invention. In the finalization area 35, the bottom level of a groove is the same as that of a pre-pit, but the depth of the groove is different from that of the pre-pit.

Referring to FIG. 5, a track including grooves 31 and lands 32 is formed in a border region of the finalization area 35 in the information recording medium 100 and pre-pits 36 are formed in a region other than the border region in the finalization area 35. In-groove pre-pits 33 are formed in the grooves 31 and LPPs 34 are formed in the lands 32, while the information recording medium 100 is manufactured. A bottom of the grooves 31 and the bottom of the pre-pits 36 are on the same level b1, but the grooves 31 and the pre-pits 36 have different depths of d1 and d2, respectively.

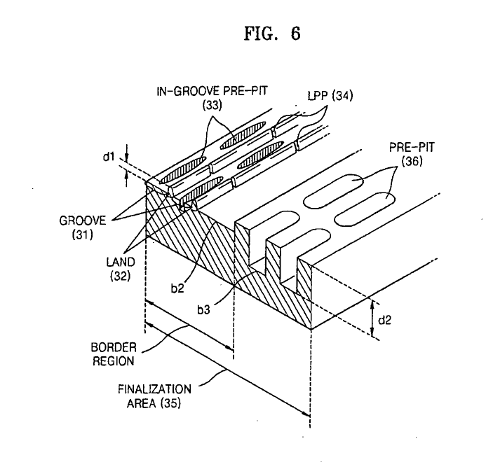

FIG. 6 illustrates an example physical form of the finalization area 35 in the information recording medium 100 shown in FIG. 3, according to another embodiment of the present invention. In the current embodiment, the bottom level of a groove is different from that of a pre-pit, and the depth of the groove is also different from that of the pre-pit.

Referring to FIG. 6, a track including grooves 31 and lands 32 is formed in a border region of the finalization area 35 in the information recording medium 100 and pre-pits 36 are formed in a region other than the border region in the finalization area 35. In-groove pre-pits 33 are formed in the grooves 31 and LPPs 34 are formed in the lands 32. In the current embodiment, the bottom of the grooves 31 is on a level b2 and the bottom of the pre-pits 36 is on a level b3. In other words, the bottom of the grooves 31 and the bottom of the pre-pits 36 are on different levels. In addition, the grooves 31 and the pre-pits 36 have different depths of d1 and d2, respectively.

In the above-described embodiments, a finalization area is formed only in a middle area. However, if there is other areas enabling the reduction of a finalization time, pre-pits may be formed in those areas. Accordingly, it will be understood by those skilled in the art that an area, in which pre-pits for finalization of an information recording medium are formed during manufacturing of the information recording medium, is not limited to a middle area of the information recording medium.

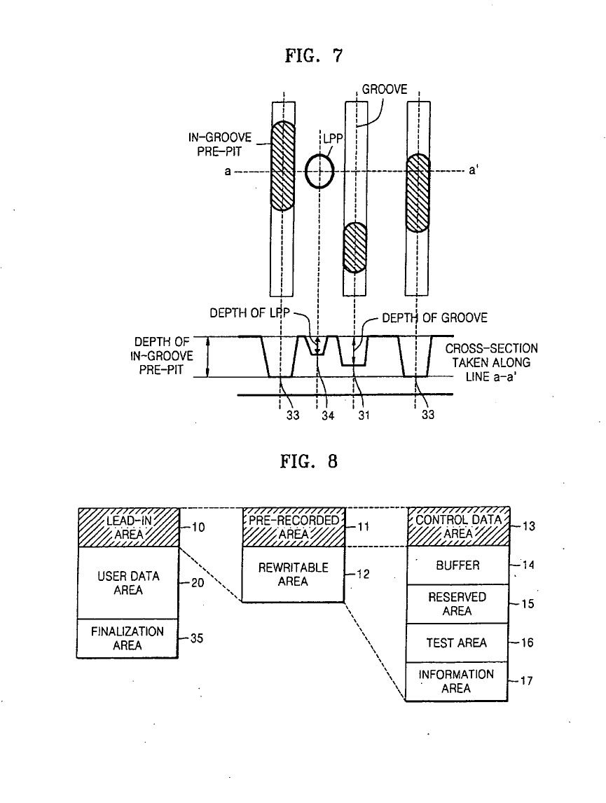

FIG. 7 illustrates a cross-section view of a border region shown in FIG. 5 or FIG. 6, according to an embodiment of the present invention. Referring to FIG. 7, a land and a groove are formed in the border region. An LPP having address information, which is referred to when data is recorded, is formed in the land and an in-groove pre-pit having address information, which is referred to when data is reproduced, is formed in the groove.

The upper part of FIG. 7 illustrates a land/groove track of the border region viewed from above, while the lower part of FIG. 7 illustrates a cross-section of the land/groove track, taken along the line a-a′. There exist three different depths: a depth of an in-groove pre-pit 33; a depth of an LPP 34; and a depth of a groove 31.

FIG. 8 illustrates an area in which information indicating that a pre-pit has been formed in a finalization area is recorded in an information recording medium, according to an example embodiment of the present invention. Referring to FIG. 8, the information recording medium includes a lead-in area 10, a user data area 20, and a finalization area 35.

The user data area 20 is an area in which user data is recorded. The finalization area 35 includes pre-pits formed in advance during manufacturing of the information recording medium. As described above, the finalization area 35 may be a middle area or any other area on the information recording medium.

The lead-in area 10 includes a pre-recorded area 11 and a rewritable area 12. The pre-recorded area 11 includes a control data area 13 in which information about the information recording medium is recorded. In particular, information indicating whether a pre-pit has been formed in the finalization area 35 may be recorded in the control data area 13. The information indicating whether a pre-pit has been formed in the finalization area 35 may be expressed in any format, but may be included in physical format information 90 shown in FIG. 9.

Referring to FIG. 9, the physical format information 90 recorded in the control data area 13 may include a disc structure 91 and a recorded density 92. In particular, the physical format information 90 may additionally include an embossed information code 93 and a middle area embossed flag 94.

FIG. 10 illustrates an example embossed information code 93 shown in FIG. 9, according to an embodiment of the present invention. Referring to FIG. 10, the embossed information code 93 is information about an embossed area in the information recording medium. For example, with respect to a middle area, when a value of a bit position 2 is “0”, the middle area has not been embossed. When the value of the bit position 2 is “1”, the middle area has been embossed with a readable emboss and an LPP area. Here, the readable emboss corresponds to an in-groove pre-pit. When the middle area is embossed with the readable emboss and the LPP area, both of a border region, which includes an in-groove pre-pit referred to during reproducing and an LPP referred to during recording, and a pre-pit region may exist in the middle area or only the border region including the in-groove pre-pit and the LPP may exist in the middle area.

FIG. 11 illustrates the middle area embossed flag 94 shown in FIG. 9, according to an embodiment of the present invention. Referring to FIG. 11, the middle area embossed flag 94 indicates whether the middle has been embossed. For example, when a value of the middle area embossed flag 94 is “0000 0000b”, the middle area has not been embossed. When the value of the middle area embossed flag 94 is “0000 0001 b”, the middle area has been embossed. Here, when the middle area is embossed, the above-described border region exists. When the middle area is embossed with a readable emboss, the middle area may include both of the border region, which includes an LPP and an in-groove pre-pit, and a pre-pit region or may include only the border region, i.e., only the LPP and the in-groove pre-pit.

As described above, when the information indicating whether the middle area is embossed is recorded duplicately, reliability of the information can be increased. For example, even when a recording/reproducing apparatus cannot recognize the content of the embossed information code 93, the content of the middle area embossed flag 94 may be identified so that the false operation of the recording/reproducing apparatus can be prevented. It is apparent that information indicating whether a pre-pit has been formed in a finalization area may be recorded in an area other than the control data area 13.

FIG. 12 is a schematic diagram of a recording/reproducing apparatus 120 reading and using information indicating that a pre-pit has been formed in a finalization area. Referring to FIG. 12, the recording/reproducing apparatus 120 can record and/or reproduce data on and/or from an information recording medium 100 and includes a write/read unit 121 and a control unit 122. For purposes of brevity, the recording/reproducing apparatus 120, albeit in whole or in part, can also be referred to as a drive system which can be internal (housed within a host) or external (housed in a separate box that connects to a host (not shown). In addition, the recording/reproducing apparatus as shown in FIG. 12 may be a single apparatus or may be separated into a recording apparatus (i.e., recorder) and a reading apparatus (i.e., player).

The write/read unit 121 is controlled by the control unit 122 to record data on the information recording medium 100 and read recorded data from the information recording medium 100 in order to reproduce the data. The control unit 122 controls the write/read unit 121 to record data on and read data from the information recording medium 100 according to a command of a host, and processes data read by the write/read unit 121 to obtain effective data. The host may be provided outside or inside the recording/reproducing apparatus 120.

In particular, when the information recording medium 100 is finalized, the control unit 122 controls the write/read unit 121 to read “information indicating whether a pre-pit has been formed in the finalization area” from the control data area 13 in the information recording medium 100. When the write/read unit 121 reads the “information indicating whether a pre-pit has been formed in the finalization area” from the control data area 13 and provides the same to the control unit 122, the control unit 122 determines whether a pre-pit has been formed in the finalization area based on the information provided by the write/read unit 121.

When a pre-pit has been formed in the finalization area, the control unit 122 does not uselessly control the write/read unit 121 to record data into the finalization area during finalization of the information recording medium 100. When a pre-pit has not been formed in the finalization area, the control unit 122 surely controls the write/read unit 121 to record data into the finalization area during the finalization of the information recording medium 100.

In addition, when data is recorded in a data recordable area adjacent to the finalization area in the information recording medium 100, an LPP signal can be obtained from a border region, which includes both of an LPP and an in-groove pre-pit formed in a part of the finalization area or in the entire finalization area, so that a data recording start point can be exactly found. When data is reproduced from a data area adjacent to the finalization area in the information recording medium 100, an in-groove pre-pit signal can be obtained from the border region so that a data reproducing start point can be exactly found.

As described above, when a pre-pit is formed in an area which needs to be filled with data during finalization of an information recording medium while the information recording medium is manufactured, according to example embodiments of the present invention, time taken for a user to finalize the information recording medium is reduced and the user can quickly finalize the information recording medium. In addition, according to the present invention, both of an LPP and an in-groove pre-pit are formed in a portion of a finalization area adjacent to a data recordable area, so that data can be efficiently recorded in and reproduced from the data recordable area.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the information recording medium may consist of multiple recording layers to increase the potential data storage capabilities. In addition, the prepits pre-formed in the finalization area may be any depth necessary to ensure strong reproduction signals from the prepits and may be located in any place in the information storage medium. Accordingly, it is intended, therefore, that the present invention not be limited to the various example embodiments disclosed, but that the present invention includes all embodiments falling within the scope of the appended claims.

What is claimed is:

1. An information storage medium comprising:
a user data area to record user data; and
a finalization area of which both of an in-groove pre-pit and a land pre-pit are formed in at least a part while the information storage medium is manufactured.

2. The information storage medium of claim 1, wherein an embossed pre-pit is further formed in at least a part of the finalization area.

3. The information storage medium of claim 1, wherein the finalization area comprises a middle area disposed between the user data area and one of a lead-in area and a lead-out area.

4. The information storage medium of claim 1, wherein the in-groove pre-pit and the land pre-pit are formed adjacent to an area in which data recording or reproducing starts.

5. The information storage medium of claim 1, wherein information indicating whether a pre-pit has been formed in the finalization area is recorded in a predetermined area of the information storage medium.

6. The information storage medium of claim 5, wherein the predetermined area comprises a lead-in area in the information storage medium or a control data area included in the lead-in area.

7. A recording/reproducing apparatus for recording data on or reproducing data from an information storage medium, the recording/reproducing apparatus comprising:
a write/read unit arranged to record data on or read recorded data from the information storage medium comprising a finalization area of which both of an in-groove pre-pit and a land pre-pit are formed in at least a part while the information storage medium is manufactured; and
a control unit arranged to control the write/read unit to read information indicating that a pre-pit has been formed in the finalization area from a predetermined area in the information storage medium and control a data recording operation based on the information.

8. The recording/reproducing apparatus of claim 7, wherein the finalization area comprises a middle area disposed between the user data area and one of a lead-in area and a lead-out area.

9. A recording/reproducing apparatus for recording data on or reproducing data from an information storage medium, the recording/reproducing apparatus comprising:
a write/read unit arranged to record data on or read recorded data from the information storage medium comprising a finalization area of which both of an in-groove pre-pit and a land pre-pit are formed in at least a part while the information storage medium is manufactured; and
a control unit arranged to control the write/read unit to record data on or reproduce data from a data area adjacent to the finalization area referring to address information of a part of the finalization area in which the in-groove pre-pit and the land pre-pit are formed.

10. The recording/reproducing apparatus of claim 9, wherein the finalization area comprises a middle area disposed between the user data area and one of a lead-in area and a lead-out area.

11. A method of recording data in or reproducing data from an information storage medium, the method comprising:
reading information indicating that a pre-pit has been formed in a finalization area from a predetermined area in the information storage medium of which both of an in-groove pre-pit and a land pre-pit are formed in at least a part of the finalization area, while the information storage medium is manufactured; and
controlling a data recording operation based on the information.

12. The method of claim 11, wherein the finalization area comprises a middle area disposed between the user data area and one of a lead-in area and a lead-out area.

13. A method of recording data on or reproducing data from an information storage medium, the method comprising:
recording data in a data area adjacent to a finalization area in the information storage medium, or reproducing recorded data from the data area adjacent to a finalization area in the information storage medium referring to address information of a portion of the finalization area of which both of an in-groove pre-pit and a land pre-pit are formed therein, while the information storage medium is manufactured.

14. The method of claim 13, wherein the finalization area comprises a middle area disposed between the user data area and one of a lead-in area and a lead-out area.

15. The method of claim 13, wherein a depth of the in-groove pre-pit is different from a depth of the land pre-pit.

16. The method of claim 13, wherein information indicating whether the pre-pit is formed in the finalization area is recorded in a predetermined area of the information recording medium.

17. An apparatus for recording data on an information recording medium or reproducing data recorded on the information recording medium, the apparatus comprising:
a write/read unit arranged to record data on the information recording medium or to read data from the information recording medium; and
a control unit configured to control the write/read unit to read information indicating whether a pre-pit has been formed in a finalization area, and to control a data recording operation based on the information indicating whether a pre-pit has been formed in a finalization area.

18. The apparatus of claim 17, wherein the information indicating whether the pre-pit has been formed in the finalization area, is recorded in a control data area of the information recording medium.

19. The apparatus of claim 17, wherein, when the information indicates that the pre-pit has been formed in the finalization area, the control unit controls the write/read unit not to record data in the finalization area during the process of finalizing the information recording medium, and when the information indicates that the pre-pit has not been formed in the finalization area, the control unit controls the write/read unit to record data in the finalization area during the process of finalizing the information recording medium.

20. The apparatus of claim 17, wherein the finalization area comprises a middle area disposed between the user data area and one of a lead-in area and a lead-out area.
